(19) United States
(12) Patent Application Publication
(10) Pub. No.: US 2018/0205222 A1
(43) Pub. Date: Jul. 19, 2018

(54) Controlling Current in a Supercapacitor Cathodic Protection System

(71) Applicant: Corrpro Companies, Inc., Medina, OH (US)

(72) Inventors: George Hayes, Chiefland, FL (US); Clement A. Firlotte, Medina, OH (US)

(73) Assignee: Corrpro Companies, Inc., Medina, OH (US)

(21) Appl. No.: 15/861,808

(22) Filed: Jan. 4, 2018

Related U.S. Application Data
(60) Provisional application No. 62/448,098, filed on Jan. 19, 2017.
(60) Provisional application No. 62/515,012, filed on Jun. 5, 2017.

(51) Int. Cl. H02H 9/02; H01G 11/10; H02J 3/38; H02N 11/00; H02J 7/34

(52) U.S. Cl. CPC H02H 9/02; H01G 11/10; H02J 7/345; H02J 3/386; H02N 11/002; H02J 3/383

(57) ABSTRACT

In an embodiment, an impressed current cathodic protection system includes at least one parallel-charge, serial-discharge supercapacitor bank to increase the duty cycle of the system. In another embodiment, the output of the parallel-charge, serial-discharge supercapacitor bank is applied to an anode using pulse width modulation to apply the correct amount of current to maintain a mesh potential at a desired value. In yet another embodiment, an impressed current cathodic protection system includes a microcomputer controller configured to maximize efficiency of the system.

### CROSS-REFERENCE TO RELATED APPLICATIONS

This application claims priority to U.S. Provisional Patent Application Ser. No. 62/448,098, filed Jan. 19, 2017, and U.S. Provisional Patent Application Ser. No. 62/515,012, filed Jun. 5, 2017. The entire contents of the above-identified applications are expressly incorporated herein by reference, including the contents and teachings of any references contained therein.

### BACKGROUND

Aspects of the present invention generally relate to the field of impressed current cathodic protection (ICCP) systems.

ICCP systems may be solar powered and are utilized to protect metallic structures (e.g., bridge piles) installed in electrolytic media (e.g., sea water) from electrochemical corrosion and deterioration. The ICCP systems use a direct current (DC) power source to provide a negative potential between electrodes external to the protected structure and the protected structure itself. Applying the DC current to the electrodes causes them to become positive anodes from which the applied current flows. This impressed current flows from the anodes, through the electrolytic medium, and is received by the surface of the protected structure. The structure thus becomes the cathode and polarization of the protected structure occurs.

Conventional ICCP systems utilize chemical batteries, which require maintenance and frequent replacement. The batteries must also be installed in easily accessible locations to perform the required maintenance and replacement. Moreover, chemical batteries have a fixed voltage output and are susceptible to overcharge and undercharge, which limits battery life. These ICCP systems also utilize conventional photovoltaic cells (e.g., solar cells) that are obtrusive to the appearance of the protected structure, difficult to install at many sites due to size and shape issues, and provide fixed voltages too high for use in ICCP systems.

### SUMMARY

Aspects of the invention relate to ICCP systems that include at least one parallel-charge, serial-discharge supercapacitor bank to increase the duty cycle of the ICCP system. In an embodiment, an ICCP system includes a plurality of parallel-charge, serial-discharge supercapacitor banks to double the system capacity. Additional aspects of the invention relate to applying the output of the parallel-charge, serial-discharge supercapacitor bank to an anode using pulse width modulation to ensure the correct amount of current is applied to maintain a mesh potential at a desired value. Further aspects of the invention relate to ICCP systems including a microcomputer controller configured to maximize efficiency of the system. Moreover, photovoltaic cells of an ICCP system in accordance with an aspect of the invention are supported by a jacket surrounding at least a portion of the protected structure. Furthermore, photovoltaic cells providing direct current to an ICCP system in accordance with an aspect of the invention are supplemented by at least one of a wave action current generator, a thermoelectric generator, a sea water battery, and a wind generator.

A system embodying aspects of the invention includes an electrical current source, an anode, a microcomputer controller, a mesh, and a first supercapacitor bank. The mesh is configured for attachment to at least a portion of a structure submerged in an electrolytic media. The first supercapacitor bank is configured for electrical coupling to the electrical current source, the anode, and the mesh, and communicative coupling to the microcomputer controller. The first supercapacitor bank includes a plurality of supercapacitors connected to each other by a plurality of switches. The microcomputer controller configures the plurality of switches to connect the supercapacitors in parallel when the first supercapacitor bank receives electric current from the electrical current source. Moreover, the microcomputer controller configures the plurality of switches to connect the supercapacitors in series when the first supercapacitor bank provides electric current to the anode and the mesh.

Another system embodying aspects of the invention includes an anode, a PWM regulator, a microcomputer controller, a mesh, and one or more supercapacitors. The mesh is configured for attachment to at least a portion of a structure submerged in an electrolytic media. The microcomputer controller is configured to measure an instant off potential value of the mesh and compare it to a desired potential value. The PWM regulator is configured to provide electric current from the supercapacitors to the anode using pulse width modulation to maintain the instant off potential value of the mesh at the desired potential value.

A method embodying aspects of the invention includes charging a plurality of supercapacitors with electric current from an electric current source. In an embodiment, the charging is performed at least in part by configuring a plurality of switches to connect the supercapacitors in parallel with the electric current source. The method further includes measuring an instant off potential value of a mesh attached to at least a portion of a structure submerged in an electrolytic media. The measured instant off potential value is compared to a desired potential value. The desired potential value is a desired voltage potential between an anode and the portion of the structure submerged in the electrolytic media. The method further includes providing electric current from the supercapacitors to the anode when the measured instant off potential value differs from the desired voltage potential. In an embodiment, the electric current is provided by configuring the plurality of switches to connect the supercapacitors in series with the anode and the mesh.

Other objects and features will be in part apparent and in part pointed out hereinafter.

### BRIEF DESCRIPTION OF THE DRAWINGS

FIG. 1 is a block diagram of an exemplary impressed current cathodic protection (ICCP) system according to an embodiment.

FIGS. 2A and 2B illustrate exemplary circuits formed by supercapacitors and switches of the ICCP system of FIG. 1.

FIG. 3 is a block diagram of an exemplary pulse width modulation regulator according to an embodiment.

FIG. 4 illustrates aspects of an exemplary housing of a standalone controller for the ICCP system of FIG. 1 according to an embodiment.

FIG. 5 is a block diagram of an exemplary ICCP system having one or more alternative power sources according to an embodiment.

FIGS. 6 and 7A-C illustrate exemplary wave action current generators for the ICCP systems of FIGS. 1 and 5 according to an embodiment.

FIGS. 8 and 9 illustrate exemplary flexible arrays of photovoltaic cells covering a pile jacket for the ICCP systems of FIGS. 1 and 5 according to an embodiment.

FIG. 10 illustrates an exemplary sea water battery for the ICCP systems of FIGS. 1 and 5 according to an embodiment.

FIGS. 11A and 11B illustrate an exemplary wind generator for the ICCP systems of FIGS. 1 and 5 according to an embodiment.

Corresponding reference characters indicate corresponding parts throughout the drawings.

### DETAILED DESCRIPTION

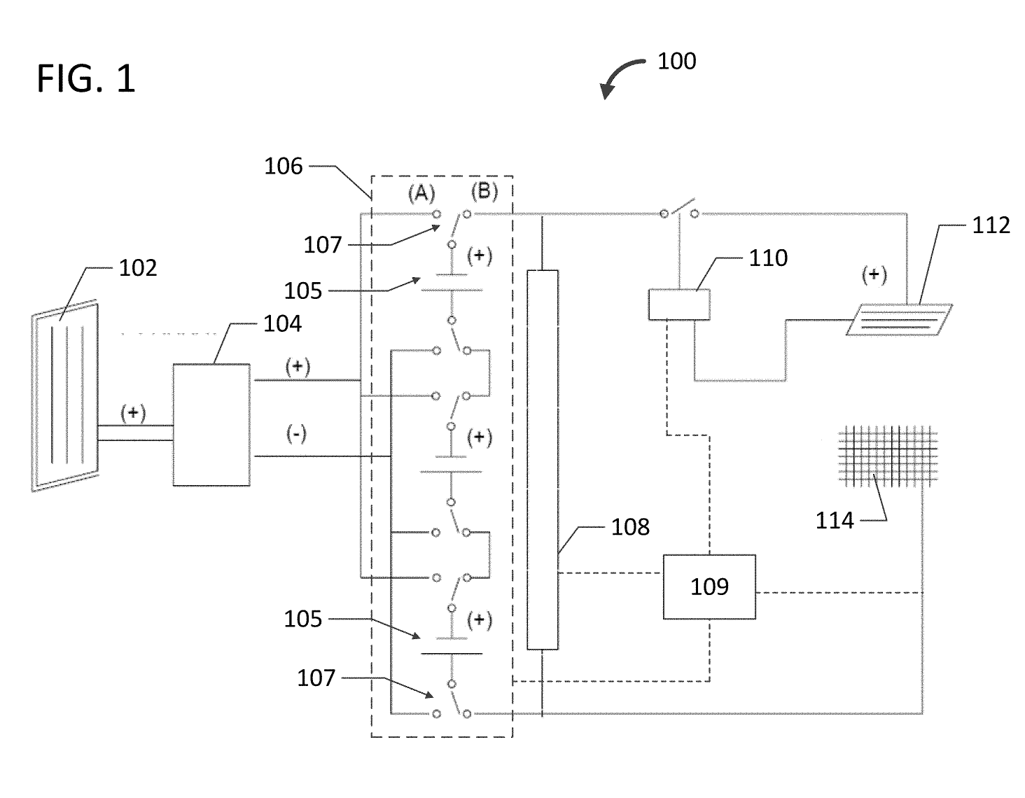

FIG. 1 is a block diagram of an exemplary impressed current cathodic protection (ICCP) system, generally indicated at 100, in accordance with an aspect of the invention. The ICCP system 100 includes an array 102 of photovoltaic (PV) cells (e.g., solar cells), a supercapacitor charging circuit and voltage regulator 104, a first supercapacitor bank 106, a second supercapacitor bank 108, a microcomputer controller 109, a pulse width modulation (PWM) regulator 110, an anode 112, and a cathodic mesh 114.

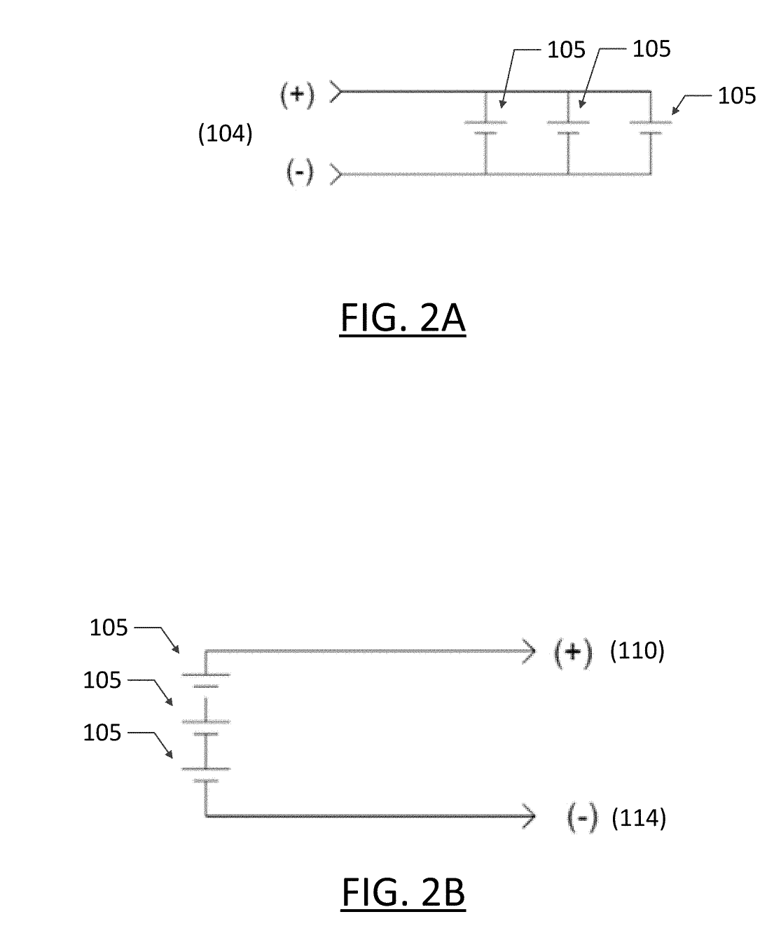

As shown in detail with respect to first supercapacitor bank 106, a plurality of switches 107 connect the supercapacitors 105 of each bank 106, 108 in parallel to the supercapacitor charging circuit and voltage regulator 104 when the switches 107 are in the (A) position. FIG. 2A illustrates an exemplary circuit formed by the supercapacitors 105 when the switches are in the (A) position. As illustrated, the supercapacitors 105 are connected in parallel between the positive and negative terminals of the supercapacitor charging circuit and voltage regulator 104. When the supercapacitors 105 are fully charged, the switches are moved to the (B) position and connected in series to the output (e.g., load). FIG. 2B illustrates an exemplary circuit formed by the supercapacitors when the switches are in the (B) position. As illustrated, the supercapacitors 105 are connected in series between the PWM regulator 110 (e.g., the positive terminal) and the cathodic mesh 114 (e.g., the negative terminal). In an embodiment, the switches are double pole, double throw (DPDT) switches.

Referring again to FIG. 1, the switches 107 each comprise a metal-oxide-semiconductor field-effect transistor (MOSFET) in accordance with an embodiment of the invention. In an embodiment, the supercapacitors 105 are limited to an output of 2.5 Volts direct current (VDC). The output voltage of first supercapacitor bank 106 is 2.5 times the number of capacitors (e.g., 2.5× (number of capacitors)). Because of the parallel-charge, serial-discharge configuration, the supercapacitors charge much faster than they are discharged into the circuit, which results in an extremely high duty cycle ratio. Exemplary extremely high duty cycle ratios include, but are not limited to, 5:1 and the like.

The second supercapacitor bank 108 may be optionally included in ICCP system 100 to prevent ICCP depolarization and/or double the system capacity. When included, the second supercapacitor bank 108 includes supercapacitors 105 and switches 107 connected in the same way as shown and described in connection with first supercapacitor bank 106. The supercapacitors 105 of second supercapacitor bank 108 utilize an inverted input/output (I/O) cycle relative to first supercapacitor bank 106 so that one supercapacitor bank is connected to the supercapacitor charging circuit and voltage regulator 104 and charging while the other supercapacitor bank is connected to the output and discharging. The first supercapacitor bank 106 and/or second supercapacitor bank 108 may each be referred to as a parallel-charge, serial-discharge supercapacitor bank in accordance with one or more embodiments of the invention.

The output of the supercapacitors 105 (e.g., first supercapacitor bank 106 and/or second supercapacitor bank 108) is applied to the anode 112 using pulse width modulation (PWM). The microcomputer controller 109 controls the operation of the regulator 110, as further described herein. In an embodiment, the microcomputer controller 109 measures the instant off potential of the mesh 114 and compares it to the desired potential. Based on this comparison, the microcomputer controller 109 controls the PWM circuit 110 to apply just the correct amount of current to maintain the potential of mesh 114 at the desired value. In an embodiment, the pulse width modulation of the current is most efficient when the input/output voltage ratio is low (e.g., 2 Volts or less). In an embodiment, mesh 114 is comprised of titanium, which provides a stable voltage reference. For example, the output curve of titanium mesh 114 compares well with Ag/Cl reference cells. Advantages of titanium mesh 114 include greater reliability than embedded Ag/Cl reference cells and greater durability.

In accordance with an embodiment, the microcomputer controller 109 provides various “smart” techniques to maximize the efficiency of ICCP system 100. In an exemplary embodiment, the microcomputer controller 109 lowers the potential of mesh 114 at night to preserve the charge of the supercapacitors. In another exemplary embodiment, the microcomputer controller 109 monitors the time of day and ensures both first supercapacitor bank 106 and second supercapacitor bank 108 (e.g., in a two-bank embodiment) are fully charged at sunset. In yet another embodiment, the microcomputer controller 109 connects both first supercapacitor bank 106 and second supercapacitor bank 108 to the output (e.g., switch position (B)) at night. In accordance with another embodiment, the microcomputer controller 109 ensures the supercapacitor bank (e.g., in a one-bank embodiment) is kept fully charged while the array 102 of PV cells is providing current to account for the uncertainty due to weather conditions or the like. In another embodiment, the microcomputer controller 109 comprises an extremely low-power central processing unit (CPU).

As described more fully hereinafter, the PV cells of array 102 can be built into a structure (e.g., bridge) protected by ICCP system 100. For example, glass PV cells may be installed using thinset and grout and flexible PV cells may be glued to the structure (e.g., columns, barriers, stem walls, etc.). Moreover, the PV cells of array 102 may be used as decorative tiles and/or installed as trim or other aesthetic enhancements to the structure.

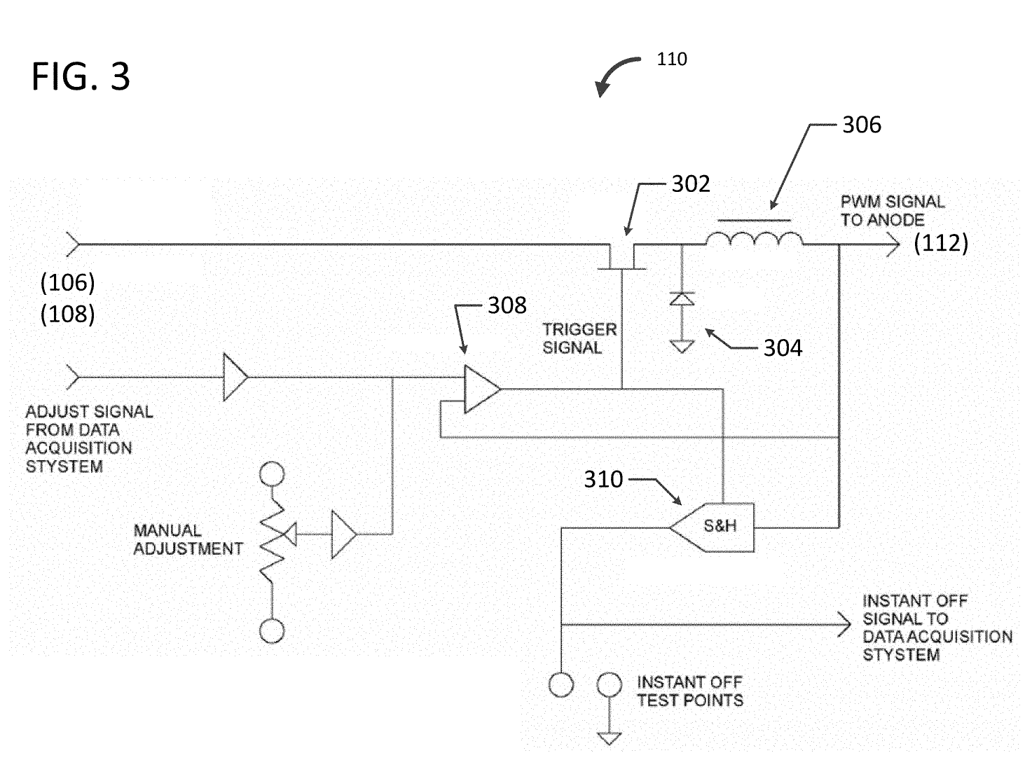

FIG. 3 is an exemplary simplified block diagram of the PWM regulator 110, in accordance with an embodiment of the invention. In the exemplary embodiment, the PWM regulator includes a MOSFET power switch 302, a diode 304, an inductor 306, a comparator 308, and a sample and hold (S&H) circuit 310. The MOSFET power switch 302 is connected to a source of direct current (e.g., first supercapacitor bank 106 and/or second supercapacitor bank 108). In a preferred embodiment, the source voltage is limited to about three volts above the desired output voltage. The PWM regulator 110 has three maximum ranges (e.g., 2.5 VDC, 5 VDC, and 10 VDC) to accommodate this limit. The output of the MOSFET power switch 302 is an analog voltage. The PWM pulse is smoothed out by the filtering action of the inductor 306 and the storage capacity of the cathodic protection circuit. In an embodiment, the switching frequency of the MOSFET power switch 302 is about 20 kHz to about 50 kHz.

In operation, the voltage of an external reference cell and/or the mesh 114 is applied to one input of the comparator 308. In an embodiment, the comparator 308 is an integrated circuit (IC). This voltage is also applied to the input of the S&H circuit 310, as further described herein. A reference voltage equal to the desired system potential is applied to the other input of the comparator 308 (e.g., adjust signal from data acquisition system and/or manual adjustment). When the potential of mesh 114 is lower than the desired potential, the output of comparator 308 is at a high level. The output of comparator 308 is connected to the gate of the MOSFET power switch 302. When the output of comparator 308 is at the high level, the MOSFET power switch 302 turns ON and applies current to the cathodic protection circuit, which causes the potential of mesh 114 to rise. When the mesh voltage is equal to the reference voltage, the output of comparator 308 is at a low level. When the output of comparator 308 is at the low level, the MOSFET power switch 302 turns OFF and the voltage of mesh 114 begins to drop. When the voltage of mesh 114 is lower than the reference set point, the output of comparator 308 is at a high level and MOSFET power switch 302 turns back ON. This cycle continues to maintain the voltage of mesh 114 at the reference voltage value. In an embodiment, the ON and OFF set points are separated by a few millivolts to prevent noise from causing repeated triggering of the circuit (i.e., hysteresis).

When the MOSFET power switch 302 turns OFF the falling edge of the gate signal triggers the S&H circuit 310 to take a reading. The S&H circuit 310 reads the input voltage and applies it to the output as long as the trigger input is at a LOW level. When the trigger input is at a HIGH level, the input is cut off and the output stays at the value present on the input when the trigger was at the LOW level. The output of the S&H circuit 310 represents the OFF potential of mesh 114 and/or a reference cell. This output voltage is used to adjust the reference set point value of comparator 308. In a manual adjustment mode, a user connects a voltmeter to test points connected to the output of S&H circuit 310. In an automatic adjustment mode, a data acquisition module reads the output of S&H circuit 310.

In accordance with an embodiment of the invention, PWM regulator 110 achieves a very high efficiency by precisely controlling the current into the cathodic protection circuit. The cathodic protection circuit temporarily stores the current, which lowers the duty cycle (e.g., the ON to OFF ratio) of the output of PWM regulator 110. The inductor 306 in series with the MOSFET power switch 302 improves the instantaneous rate of voltage change over time (i.e., dV/dT) of the circuit. In an embodiment, inductor 306 possesses a small inductance. For example, inductor 306 may possess a small inductance somewhat greater than 1 millihenry (mH). In an embodiment, the diode 304 returns the inductor 306 current to the circuit of PWM regulator 110 to improve efficiency.

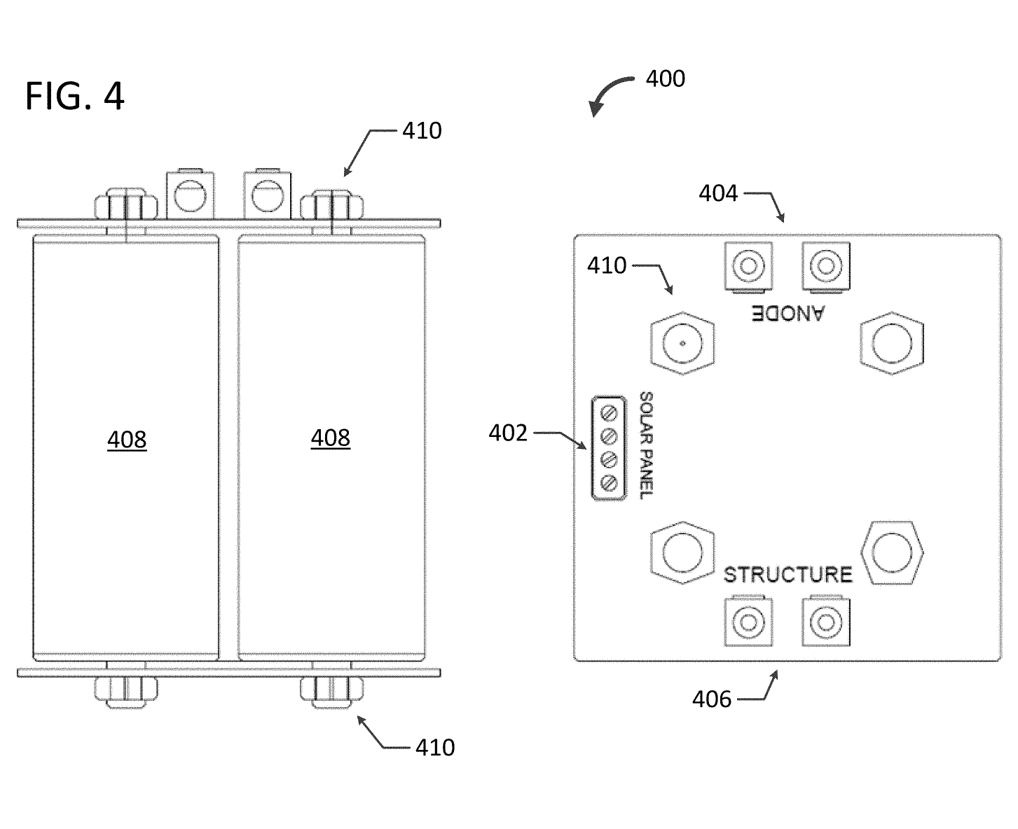

FIG. 4 illustrates aspects of an exemplary housing of a standalone controller 400 for a supercapacitor ICCP system in accordance with an embodiment of the invention. In an embodiment, controller 400 includes the supercapacitor charging circuit and voltage regulator 104, the first supercapacitor bank 106, the second supercapacitor bank 108, the pulse width modulation (PWM) regulator 110, and the microcomputer controller 109.

In another exemplary embodiment, controller 400 includes four 3000 Farad supercapacitors (e.g., supercapacitors 105) and switching networks (e.g., switches 107) to provide a variety of output options up to 10 VDC. The controller 400 is field configurable for a number of output options. The controller 400 connects directly to a 5 volt solar panel array (e.g., array 102) via a solar panel terminal 402 and to the anode (e.g., anode 112) and steel structures (e.g., mesh 114) of the ICCP system via an anode terminal 404 and a structure terminal 406, respectively. The controller 400 contains a high-efficiency pulse width modulation regulator (e.g., PWM regulator 110) to maintain a constant anode voltage or instant off potential of the cathodic protection circuit. The output voltage can be controlled by a potentiometer mounted on a circuit board and/or by connecting an optional remote monitoring/control module. In an embodiment, a user can select from three output voltages (e.g., 2.5 VDC, 5.0 VDC, or 10.0 VDC). For example, the output voltage may be selected using jumpers on a bottom printed circuit board (PCB) assembly. Connections (e.g., to the solar panel array, anode, etc.) are made using connectors on a top PCB assembly.

In an embodiment, controller 400 includes four MAXWELL BCAP300-K04 3000 FARAD supercapacitors 408. The supercapacitors are supplied with M12 studs 410 on each end. The top (e.g., identified by the wiring connectors) circuit board of the controller 400 has four holes that will accept the M12 stud. Each supercapacitor is mounted to the board by inserting the stud in one of the holes, installing an included nut, and tightening. After mounting all of the supercapacitors to the top circuit board, the assembly is turned over and the bottom circuit board is mounted on all four supercapacitor studs. Again, the supercapacitors are mounted by installing M12 nuts and tightening. The solar array is connected to a four-circuit connector (e.g., solar panel terminal 402) as shown in FIG. 4. In an embodiment, the four-circuit solar array connector is green. In another embodiment, the board indicates which terminals of the four-circuit solar array connector are positive (+) and which terminals are negative (−). The anode wire(s) are connected to at least one of the connectors marked “ANODE” (e.g., anode terminal 404). The structure wire(s) are connected to at least one of the connectors marked “STRUCTURE” (e.g., structure terminal 406). In an embodiment, two connections for each of the ANODE and STRUCTURE connections are provided for convenience and either connector may be used. When solar power is available, a “POWER” light-emitting diode (LED) (not shown) is illuminated on the top circuit board. Initially, a “CHARGE” LED is illuminated (e.g., yellow). Once the supercapacitors are fully charged, the “CHARGE” LED will turn off and an “OUTPUT” LED (e.g., green) will be illuminated. This cycle will continue until the solar panel is no longer providing current. In an embodiment, the “OUTPUT” LED flashes every about ten seconds to indicate that controller 400 is in a nighttime discharge mode.

In an exemplary manual operation mode, controller 400 is assembled and installed as described above. The maximum operating voltage (e.g., 2.5, 5, or 10 VDC) is selected by installing jumpers on the PCB assembly. In an embodiment, the maximum voltage of controller 400 is set to the lowest available range that will meet the cathodic protection system requirements. The desired cathodic protection output voltage can be calculated or can be found by using an external power supply to determine the output voltage that will achieve the desired potential. In an embodiment, the capacity of controller 400 is higher on the lower ranges (e.g., the maximum capacity (12,000 Farads) is available on the 2.5 VDC range).

Once the controller 400 has been installed, the cathodic protection (CP) potential value must be set. In an embodiment, controller 400 has two potential set points. The first set point is used when controller 400 is in a “DAY” mode indicated by a steadily illuminated green LED (e.g., “OUTPUT” LED). The “DAY” mode allows a higher potential to be used during the day when power is available from the PV array and allows a maximum polarization to occur. To set this value, a voltmeter is connected to test points marked “POTENTIAL” and the potentiometer marked “DAY” is adjusted until the desired potential is shown on the voltmeter. To set the potential for nighttime, a pushbutton on the board labeled “NIGHT” is pushed and held down while the potentiometer marked “NIGHT” is adjusted. In an embodiment, potential cannot be set while the yellow LED (e.g., “CHARGE” LED) is illuminated. The nighttime potential setting is set to the lowest value that will maintain polarization at an acceptable level. The lower the nighttime potential setting is, the longer the supercapacitors will provide current to the CP system. One having ordinary skill in the art will understand how to determine these settings. After setting the potential values, the controller 400 is ready to operate.

If the CP system is severely depolarized it may take some time to reach the desired potential. During this time it may not be possible to set the potentials correctly. To set the potential, remove the STRUCTURE wires and install the supplied resistor, set the potentials as described above, and reconnect the CP wiring. It may take several days to reach the desired level of polarization. The output should be checked after a few days to ensure the desired potential is reached. It may be necessary to set the controller 400 on a lower voltage range and a lower potential for the first day or so. The potential should be monitored and the PWM set to a higher potential once the system has polarized to the first level. Another method is to connect a 6-volt battery to the solar connectors marked “BATTERY” for the first few days. The battery will supply additional current to the system until polarization is reached. The battery can be disconnected at this point and the system will work as indicated.

In an exemplary automatic operation mode (e.g., remote operation and monitoring of controller 400) a data acquisition/control module is connected to a connector marked “REMOTE” on the top circuit board.

An exemplary rectifier DC output module in accordance with an aspect of the invention includes the following properties:
Maximum Voltage Output Ranges:
   2.5 VDC @12,000 Farads
   5.0 VDC @6,000 Farads
   10.0 VDC @3,000 Farads
   The actual output voltage will be automatically set by the controller 400 to achieve the desired potential. The controller 400 output range is the lowest value that will maintain the desired potential.
Rectifier Output Modes: Constant ANODE Voltage, Constant Potential
Rectifier Voltage Regulation +/−0.1 Volts DC

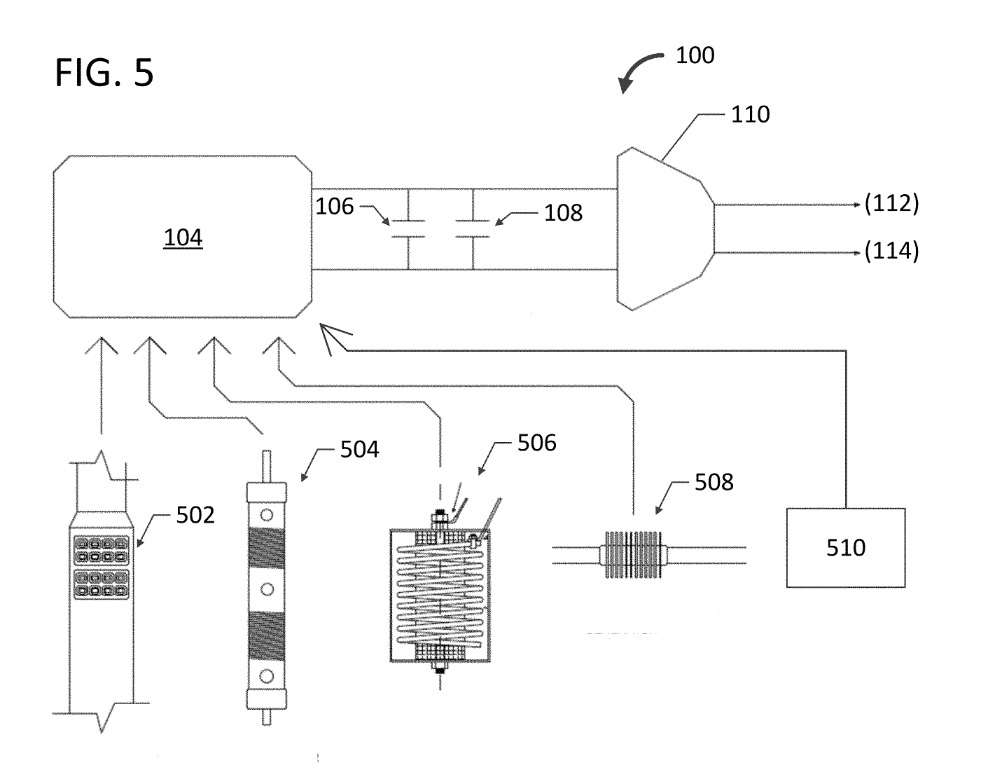

FIG. 5 is a block diagram of another exemplary embodiment of ICCP system 100 that utilizes other power sources in place of, or in addition to, the array 102 of PV cells, in accordance with an aspect of the invention. As illustrated, the power sources include a solar jacket 502, a wave action current generator 504, a sea water (e.g., salt water) battery 506, a thermoelectric generator (e.g., Seebeck generator) 508, a wind generator 510, or combinations thereof. In an embodiment, the thermoelectric generator 508 converts heat flux (e.g., temperature differences) directly into electrical energy through the Seebeck effect. In an exemplary embodiment, ICCP system 100 protects aspects of a structure used for electronic communications (e.g., radio mast, cellular telephone tower, etc.) and thermoelectric generator 508 converts waste heat generated by the electronic communications equipment into electrical energy that is stored in a supercapacitor (e.g., first supercapacitor bank 106 and/or second supercapacitor bank 108) and then applied to the CP circuit. In another exemplary embodiment, the thermoelectric generator 508 converts thermal energy stored by a concrete structure (e.g., heat stored by bridge beams/girders, piers, abutments, piles, decks, etc. as they are heated by the sun) into electrical energy that is stored in supercapacitors 105 (e.g., first supercapacitor bank 106 and/or second supercapacitor bank 108) and then applied to the CP circuit.

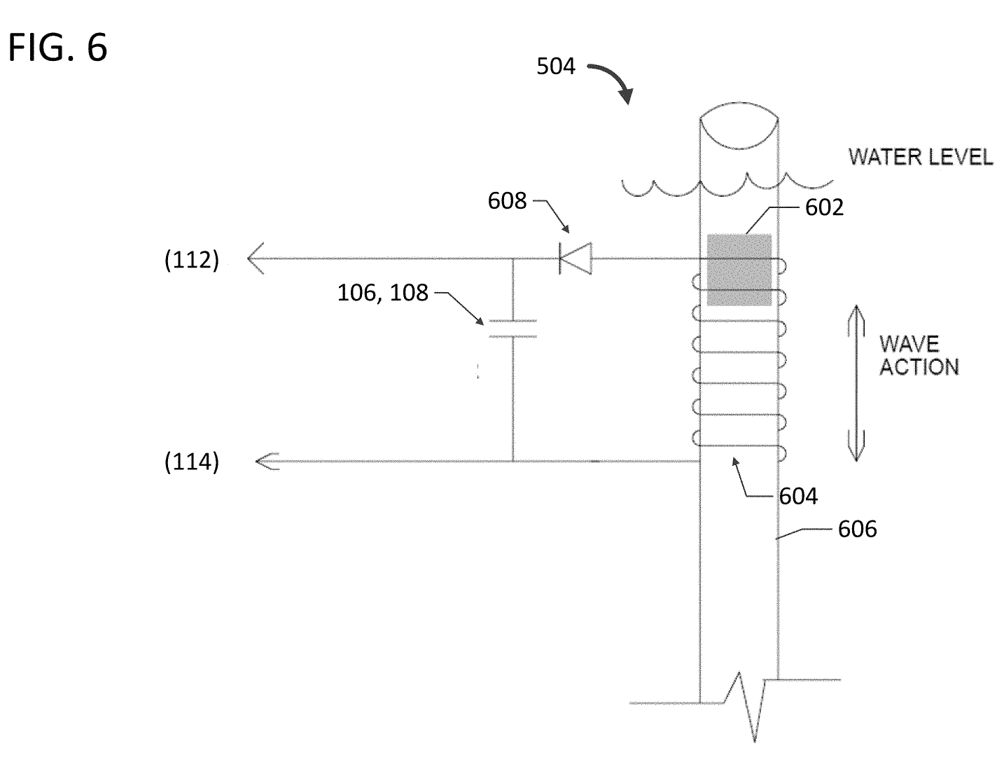

FIG. 6 illustrates an exemplary embodiment of the wave action current generator 504 that may be used in addition to the array 102 of PV cells in accordance with aspects of the invention. In operation, wave action (e.g., of water) causes a magnet 602 to move up and down within a wire coil 604 wound around a plastic (e.g., PVC) pipe 606 sealed with epoxy. In an embodiment, the plastic pipe 606 is directly attached to a jacket surrounding a pile (e.g., a bridge pile). In an embodiment, the magnet 602 is a powerful neodymium magnet sealed and attached to the float. The up and down movement within the float during wave action generates a current in the wire coil 604, which is stored in one or more supercapacitors 105 (e.g., first supercapacitor bank 106 and/or second supercapacitor bank 108) and then applied to the CP circuit. The wire coil 604 is connected to the supercapacitor banks 106, 108 and the anode 112 via a diode 608 in accordance with an aspect of the invention. In an embodiment, the wave action current generator 504 acts as a supplement to the array 102 of PV cells to generate current both day and night. In another embodiment, the wave action current generator 504 is applied to exposed locations (e.g., on and/or adjacent the structure) where significant wave action occurs.

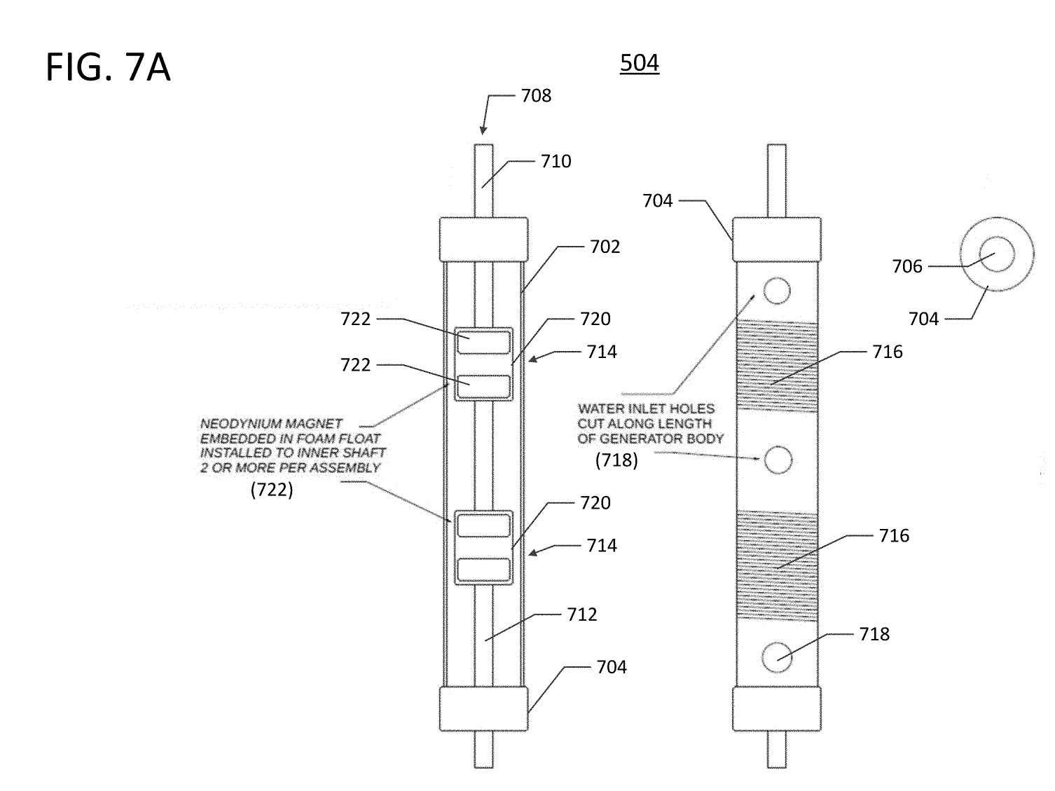

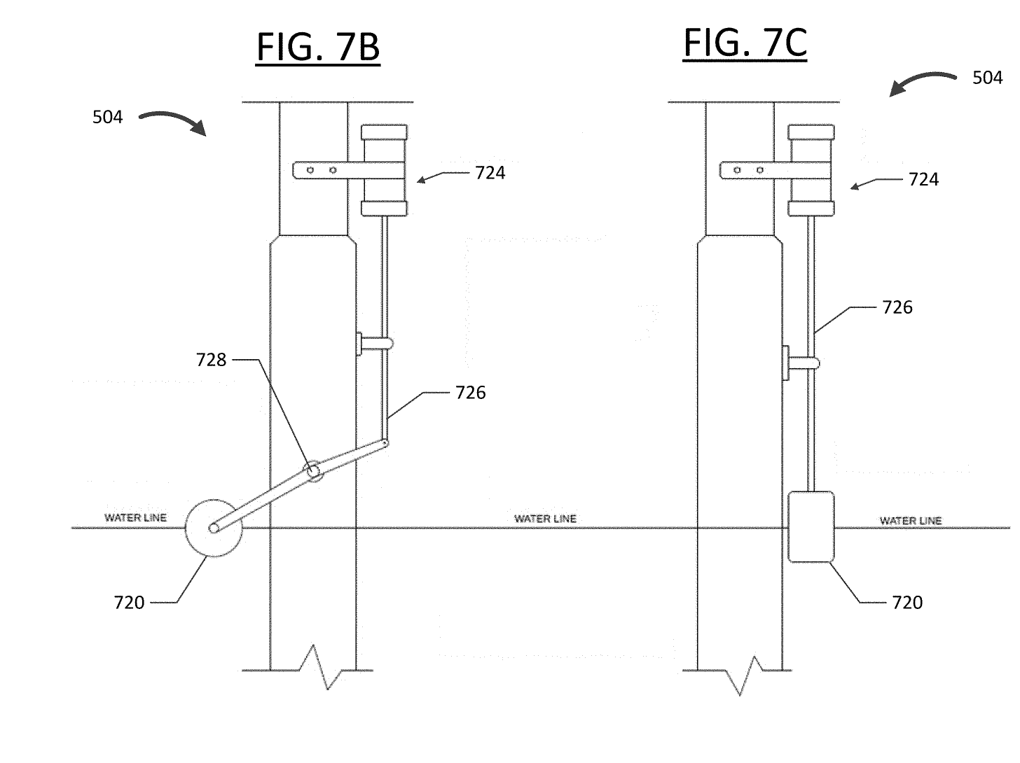

FIG. 7A illustrates a cut-away view of an exemplary embodiment of wave action current generator 504. In this embodiment, wave action current generator 504 includes a body 702, end caps 704, end cap holes 706, a guide 708 having an outer shaft 710 and an inner shaft 712, float assemblies 714, wire coils 716, and water inlets/outlets 718. The float assemblies 714 each include a float 720 and magnets 722. The guide 708 extends through the end cap holes 706 and the body 702. The magnets 722 are embedded into the float 720, which is installed to the inner shaft 712 of guide 708. In an embodiment, magnets 722 are comprised of neodymium and float 720 is comprised of closed-cell solid foam, such as polystyrene and the like. In another embodiment, each float assembly 714 includes two or more magnets 722. The body 702 includes the water inlets/outlets 718 through which water enters and exits wave action current generator 504. In the embodiment illustrated in FIG. 7, water inlets/outlets 718 are illustrated has having a circular shape but one of ordinary skill in the art will understand that the water inlets/outlets 718 may have other configurations. The wire coils 716 are wound around body 702 at locations that correspond to each float assembly 714. In an embodiment, wire coils 716 are covered with an epoxy.

As the level of water within body 702 fluctuates due to wave action, float assemblies 714 are configured to slide up and down inner shaft 712. This movement of float assemblies 714, and thus magnets 722, relative to wire coils 716 generates an electrical current in wire coils 716. This electrical current is stored in one or more supercapacitors 105 (e.g., first supercapacitor bank 106 and/or second supercapacitor bank 108) and then applied to the CP circuit, as further described herein.

FIGS. 7B and 7C illustrate exemplary alternative embodiments of wave action current generator 504. In each embodiment, the float 720 is connected to a coil and magnet assembly 724 via a linkage 726. The coil and magnet assembly 724 includes magnets 722 and wire coils 716 as further described herein. In an embodiment, coil and magnet assembly 724 is attached to a structure (e.g., bridge pile, etc.) above the water line for greater reliability, for example. In another embodiment, fouling of float 720 is alleviated by a guard (not shown). As the water line fluctuates due to wave action, float 720 stays at the water line. This movement of float 720 causes magnets 722 to correspondingly move up and down inside coil and magnet assembly 724 relative to wire coils 716. The movement of magnets 722 relative to wire coils 716 generates an electrical current in wire coils 716 that is stored in one or more supercapacitors 105 (e.g., first supercapacitor bank 106 and/or second supercapacitor bank 108) and then applied to the CP circuit, as further described herein. Referring to FIG. 7B, the linkage 726 includes one or more pivots 728 in accordance with an embodiment of the invention. The pivots 728 add mechanical advantage and makes possible increased travel of magnets 722. In an embodiment, arms are mounted on both sides of the structure (e.g., bridge pile, etc.). Referring to FIG. 7C, linkage 726 is straight such that float 720 is directly beneath coil and magnet assembly 724, in an embodiment.

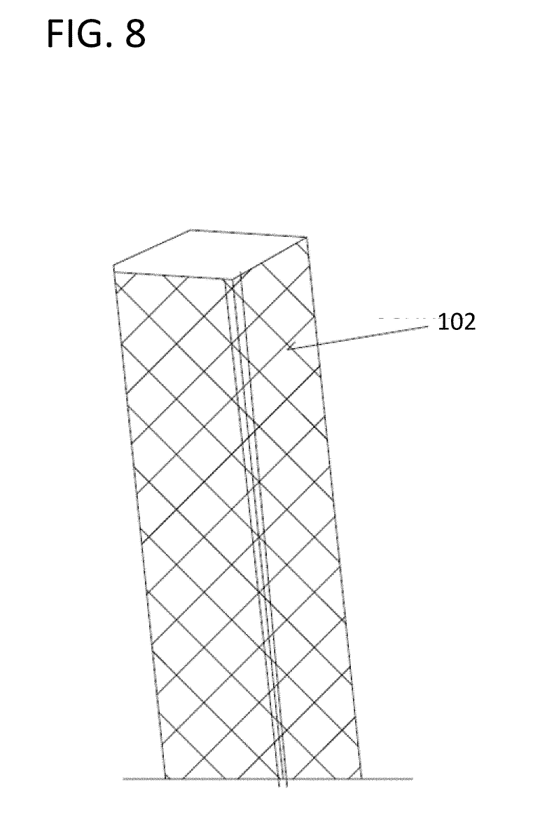

FIG. 8 illustrates an exemplary embodiment in which the array 102 of PV cells is flexible and covers the jacket around a pile (e.g. a bridge pile). In an embodiment, the PV cells are coated in a clear epoxy to protect them from the environment. In another embodiment, the amount of current generated by the flexible array of PV cells even in shade conditions is enough to power at least one jacket. Exemplary benefits of the flexible array of PV cells include pleasing aesthetics and theft reduction. In yet another embodiment, the PV cells of array 102 may be used as decorative tiles and/or installed as trim and/or other decorative/aesthetic enhancements to the structure.

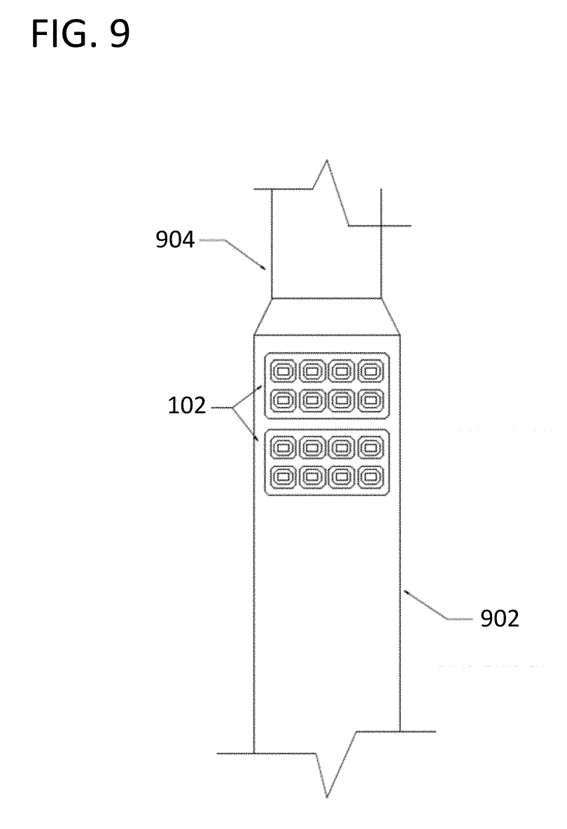

FIG. 9 illustrates another exemplary embodiment in which a plurality of arrays 102 of PV cells is flexible covers a jacket 902 around a concrete structure piling 904 (e.g., bridge pile, communications tower pile, etc.). In this embodiment, the arrays 102 of flexible PV cells are waterproof and attached to the top of fiberglass jacket 902. When jacket 902 has a discontinuous cross-section (e.g., triangular, rectangular, square, etc.), the arrays 102 of PV cells may be on one or more sides of the jacket 902. When jacket 902 has a continuous cross-section (e.g., circular, oval, etc.), the arrays 102 of PV cells wrap around jacket 902. In an embodiment, the arrays 102 of PV cells are installed on jacket 902 during fabrication of jacket 902. In another embodiment, the arrays 102 of PV cells are attached to existing jackets 902. For example, the arrays 102 may be retrofitted to galvanic jacketed anode assemblies similar to those described in U.S. Pat. No. 5,714,045. These jackets include a zinc bulk anode (e.g., zinc mass) underwater to supplement and extend the life of the zinc mesh within the jacket that is under the water. The zinc bulk anode has a separate cable that runs through the jacket and is connected to the rebar, along with the zinc mesh in the jacket, inside a top junction box. After a period of time (e.g., about 15 years) the zinc in the bulk anode tends to passivate and current output drops. In an embodiment, ICCP system 100 provides a small current to lengthen the life of the zinc bulk anode. A clear polymer epoxy coating is applied to the arrays 102 of PV cells in accordance with an aspect of the invention.

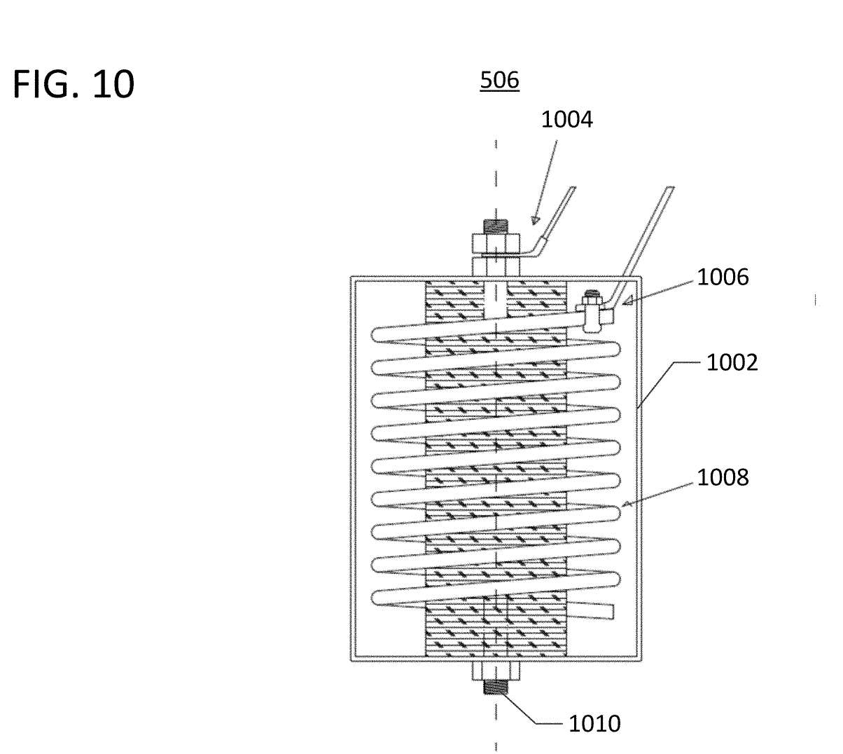

FIG. 10 illustrates a cut-away view of an exemplary embodiment of the sea water battery 506. In this embodiment, sea water battery 506 includes an outer cover 1002, a positive electrode connection 1004, a negative electrode connection 1006, a zinc coil 1008, and a continuously threaded (e.g., all thread) rod 1010. In an embodiment, the outer cover 1002 is comprised of polyvinyl chloride (PVC). In another embodiment, the continuously threaded rod 1010 is comprised of stainless steel. The continuously threaded rod 1010 penetrates graphite (not shown) for mounting sea water battery 506. The positive electrode 1004 of supercapacitor charging circuit and voltage regulator 104 connects to the continuously threaded rod 1010. The zinc coil 1008 is the negative electrode of sea water battery 506 and uses a split bolt connection as the negative connection 1006 to supercapacitor charging circuit and voltage regulator 104.

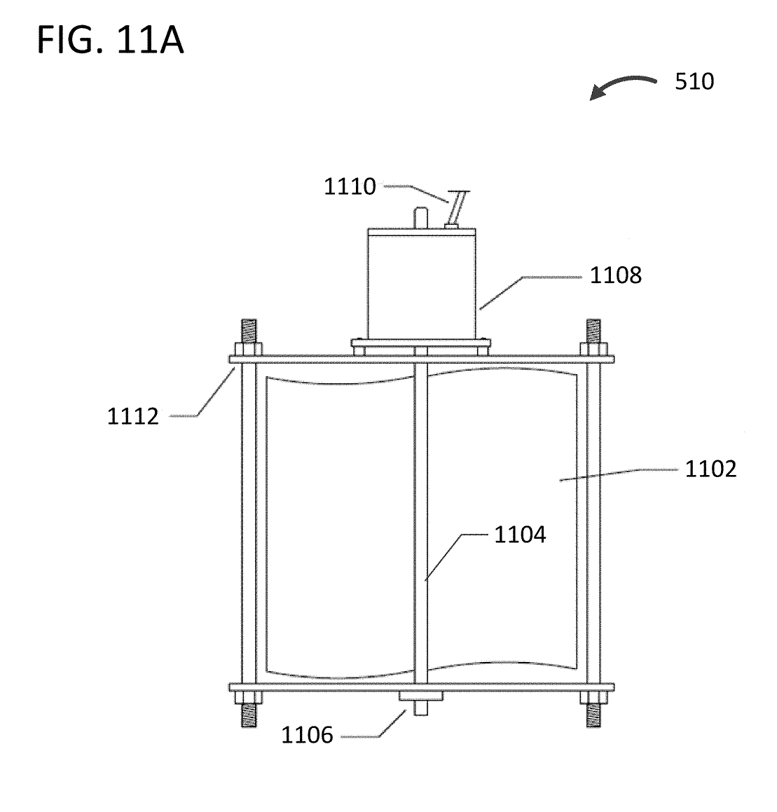

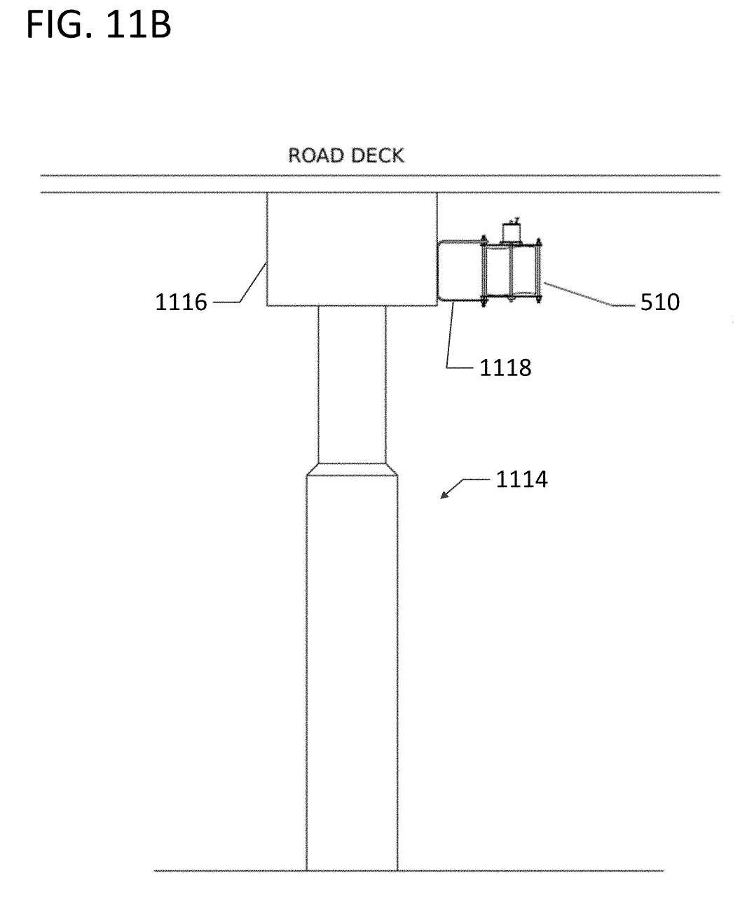

FIGS. 11A and 11B illustrate an exemplary wind generator 510 that is a power source in place of, or in addition to, the array 102 of PV cells, in accordance with an aspect of the invention. Referring to FIG. 11A, the wind generator 510 is a Savonius wind generator configured to convert the force of wind into electrical energy that is stored in one or more supercapacitors 105 (e.g., first supercapacitor bank 106 and/or second supercapacitor bank 108) and then applied to the CP circuit. The Savonius wind generator 510 includes a Savonius rotor 1102 mounted to a shaft 1104. In an embodiment, the shaft 1104 is comprised of stainless steel. One end of shaft 1104 sits in a ball bearing mount 1106 and the opposite end of shaft 1104 is coupled to a DC generator 1108. The DC generator 1108 is coupled to an energy harvesting module (e.g., supercapacitor charging circuit and voltage regulator 104) via a wire lead 1110. In an embodiment, Savonius wind generator 510 includes aluminum plate end caps 1112. Referring to FIG. 11B, Savonius wind generator 510 is mounted to a concrete structure piling 1114 (e.g., bridge pile, communications tower pile, etc.) in accordance with an aspect of the invention. In an embodiment, Savonius wind generator 510 is coupled to a bridge cap 1116 via a stainless steel “C” bracket 1118.

In an aspect, an impressed current cathodic protection system (e.g., ICCP system 100) includes an electrical current source (e.g., array 102 of PV cells, solar jacket 502, wave action current generator 504, sea water battery 506, thermoelectric generator 508, wind generator 510), an anode (e.g., anode 112), a microcomputer controller (e.g., microcomputer controller 109), a mesh (e.g., mesh 114), and a first supercapacitor bank (e.g., first supercapacitor bank 106). The mesh is configured for attachment to at least a portion of a structure (e.g., concrete structure piling 904) submerged in an electrolytic media. The first supercapacitor bank is configured for electrical coupling to the electrical current source, the anode, and the mesh, and communicative coupling to the microcomputer controller. The first supercapacitor bank includes a plurality of supercapacitors (e.g., supercapacitors 105) connected to each other by a plurality of switches (e.g., switches 107). The microcomputer controller configures the plurality of switches to connect the supercapacitors in parallel when the first supercapacitor bank receives electric current from the electrical current source. Moreover, the microcomputer controller configures the plurality of switches to connect the supercapacitors in series when the first supercapacitor bank provides electric current to the anode and the mesh. In an embodiment, the mesh is titanium.

In one form, the impressed current cathodic protection system further includes a second supercapacitor bank (e.g., second supercapacitor bank 108). The second supercapacitor bank is configured for electrical coupling to the electrical current source, the anode, and the mesh in parallel with the first supercapacitor bank. The second supercapacitor bank is further configured for communicative coupling to the microcomputer controller. The second supercapacitor bank includes a plurality of supercapacitors (e.g., supercapacitors 105) connected to each other by a plurality of switches (e.g., switches 107). The switches of the second supercapacitor bank are configured to connect the supercapacitors of the second bank in series when the switches of the first supercapacitor bank connect the supercapacitors of the first bank in parallel. Furthermore, the switches of the second supercapacitor bank are configured to connect the supercapacitors of the second bank in parallel when the switches of the first supercapacitor bank connect the supercapacitors of the first bank in series.

In another form, the impressed current cathodic protection system further includes a pulse width modulation regulator (e.g., PWM regulator 110). The pulse width modulation regulator is configured to regulate the amount of electric current the supercapacitors (e.g., of the first bank, the second bank, or both) provide to the anode. In an embodiment, the pulse width modulation regulator regulates the amount of current based on an instant off voltage of the mesh.

In yet another form, the microcomputer controller is configured to perform at least one of lowering the potential between the anode and the mesh at night and maximizing the charge of the supercapacitors at sunset.

In another form, the electrical current source comprises at least one of one or more photovoltaic cells (e.g., array 102 of PV cells, solar jacket 502), a wave action current generator (e.g., wave action current generator 504), a thermoelectric generator (e.g., thermoelectric generator 508), a sea water battery (e.g., sea water battery 506), and a wind generator (e.g., wind generator 510). The photovoltaic cells are configured to generate the electric current from light absorbed by the cells. The wave action current generator is configured to generate the electric current from one or more wave actions of the electrolytic media. The thermoelectric generator is configured to generate the electric current from thermal energy stored by the structure. The sea water battery is configured to generate the electric current from the electrolytic media. The wind generator is configured to generate the electric current from wind force against a rotor of the generator. In an embodiment, the photovoltaic cells are flexible and cover at least a portion of a jacket (e.g., solar jacket 502, jacket 902) surrounding at least a portion of the structure. In another embodiment, the wind generator is a Savonius wind generator.

In another aspect, an impressed current cathodic protection system (e.g., ICCP system 100) includes an anode (e.g., anode 112), a PWM regulator (e.g., PWM regulator 110), a microcomputer controller (e.g., microcomputer controller 109), a mesh (e.g., mesh 114), and one or more supercapacitors (e.g., supercapacitors 105). The mesh is configured for attachment to at least a portion of a structure (e.g., concrete structure piling 904) submerged in an electrolytic media. The microcomputer controller is configured to measure an instant off potential value of the mesh and compare it to a desired potential value. The PWM regulator is configured to provide electric current from the supercapacitors to the anode using pulse width modulation to maintain the instant off potential value of the mesh at the desired potential value.

In one form, the microcomputer controller is configured to perform at least one of lowering the potential between the anode the mesh at night and maximizing the charge of the supercapacitors at sunset.

In another form, the impressed current cathodic protection system further includes a direct current source configured to generate the electric current. In an embodiment, the direct current source includes one or more photovoltaic cells (e.g., array 102 of PV cells, solar jacket 502) configured to generate the electric current from light absorbed by the cells. In another embodiment, the direct current source includes a wave action current generator (e.g., wave action current generator 504) configured to generate the electric current from one or more wave actions of the electrolytic media. In yet another embodiment, the direct current source includes a thermoelectric generator (e.g., thermoelectric generator 508) configured to generate the electric current from thermal energy stored by the structure. In another embodiment, the direct current source includes a sea water battery (e.g., sea water battery 506) configured to generate the electric current from the electrolytic media. In yet another embodiment, the direct current source includes a wind generator (e.g., wind generator 510) configured to generate the electric current from wind force against a rotor of the generator.

In yet another form, the PWM regulator includes a MOSFET switch (e.g., MOSFET power switch 302), a comparator IC (e.g., comparator 308), and a S&H IC (e.g., S&H circuit 310). A source terminal of the MOSFET switch is connected to the direct current source and a drain terminal of the MOSFET switch is connected to the anode. A first input of the comparator IC is configured for connection to a reference node that is configured to be attached to at least a portion of the structure submerged in the electrolytic media. A second input of the comparator IC is configured for connection to a reference voltage that is equal to the desired potential value between the anode and the portion of the structure submerged in the electrolytic media. An output of the comparator IC is configured for connection to a gate terminal of the MOSFET switch. An input of the S&H IC is configured for connection to the reference node. The output of the comparator IC is at a high level when a voltage of the reference node is lower than the reference voltage and this high level output causes the MOSFET switch to turn on such that the electric current flows from the direct current source to the anode. The output of the comparator IC is at a low level when the voltage of the reference node is greater than or equal to the reference voltage and this low level output causes the MOSFET switch to turn off. A falling edge of the low level output triggers the S&H IC to read the input voltage of the reference node. The S&H IC applies the input voltage to an output of the S&H IC as long as the trigger input is at a low level. When the trigger input of the S&H IC is at a high level, the output of the S&H IC stays at the voltage level present on the input of the S&H IC when the trigger input was at the low level. In an embodiment, the reference node is a reference cell or the mesh. In another embodiment, the reference voltage is a signal from a data acquisition system of the impressed current cathodic protection system. In yet another embodiment, the reference voltage is a signal from a manually adjustable potentiometer of the impressed current cathodic protection system.

In another form, the impressed current cathodic protection system further includes an inductor (e.g., inductor 306) configured for connection in series between the drain terminal of the MOSFET switch and the anode. Advantageously, the inductor improves the instantaneous rate of voltage change over time of the circuit, for example.

In yet another form, the impressed current cathodic protection system further includes a diode (e.g., diode 304) connected between the drain terminal of the MOSFET switch and the inductor. The diode is configured to return the inductor current to the system.

Another aspect of the present disclosure includes a method for controlling current in a supercapacitor cathodic protection system (e.g., ICCP system 100). The method includes charging a plurality of supercapacitors (e.g., supercapacitors 105) with electric current from an electric current source (e.g., array 102 of PV cells, solar jacket 502, wave action current generator 504, sea water battery 506, thermoelectric generator 508, wind generator 510). In an embodiment, the charging is performed at least in part by configuring a plurality of switches (e.g., switches 107) to connect the supercapacitors in parallel with the electric current source. The method further includes measuring an instant off potential value of a mesh (e.g., mesh 114) attached to at least a portion of a structure (e.g., concrete structure piling 904) submerged in an electrolytic media. The measured instant off potential value is compared to a desired potential value. The desired potential value is a desired voltage potential between an anode (e.g., anode 112) and the portion of the structure submerged in the electrolytic media. The method further includes providing electric current from the supercapacitors to the anode when the measured instant off potential value differs from the desired voltage potential. In an embodiment, the electric current is provided by configuring the plurality of switches to connect the supercapacitors in series with the anode and the mesh.

In one form, the method further includes regulating, by a pulse width modulation regulator (e.g., PWM regulator 110), the electric current provided from the supercapacitors to the anode. In an embodiment, the regulation is performed by using pulse width modulation to maintain the instant off potential value of the mesh at the desired potential value.

Embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures and that can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, solid state drives (SSDs), and the like.

The computer typically includes a variety of computer readable media. Computer readable media can be any available media that can be accessed by the computer and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media are non-transitory and include, but are not limited to, RAM, ROM, EEPROM, flash memory or other memory technology, CD-ROM, digital versatile disks (DVD) or other optical disk storage, SSDs, magnetic cassettes, magnetic tape, magnetic disk storage or other magnetic storage devices, or any other medium which can be used to store the desired non-transitory information, which can accessed by the computer. Alternatively, communication media typically embody computer readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as video adapter 48. In addition to the monitor, personal computers typically include other peripheral output devices (not shown), such as speakers and printers.

One or more aspects of the disclosure may be embodied in computer-executable instructions (i.e., software), routines, or functions stored in system memory or non-volatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

Embodiments may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An impressed current cathodic protection system, comprising:
an electrical current source;
an anode;
a microcomputer controller;
a mesh configured for attachment to at least a portion of a structure submerged in an electrolytic media; and
a first supercapacitor bank, wherein the first supercapacitor bank is configured for electrical coupling to the electrical current source, the anode, and the mesh, wherein the first supercapacitor bank is configured for communicative coupling to the microcomputer controller, and wherein the first supercapacitor bank includes a plurality of supercapacitors connected to each other by a plurality of switches,
wherein the microcomputer controller configures the plurality of switches to connect the supercapacitors in parallel when the first supercapacitor bank receives electric current from the electrical current source, and
wherein the microcomputer controller configures the plurality of switches to connect the supercapacitors in series when the first supercapacitor bank provides electric current to the anode and the mesh.

2. The impressed current cathodic protection system of claim 1, further comprising a second supercapacitor bank,
wherein the second supercapacitor bank is configured for electrical coupling to the electrical current source, the anode, and the mesh in parallel with the first supercapacitor bank,
wherein the second supercapacitor bank is configured for communicative coupling to the microcomputer controller,
wherein the second supercapacitor bank includes a plurality of supercapacitors connected to each other by a plurality of switches,
wherein the switches of the second supercapacitor bank are configured to connect the supercapacitors thereof in series when the switches of the first supercapacitor bank connect the supercapacitors of the first supercapacitor bank in parallel, and
wherein the switches of the second supercapacitor bank are configured to connect the supercapacitors thereof in parallel when the switches of the first supercapacitor bank connect the supercapacitors of the first supercapacitor bank in series.

3. The system of claim 1, further comprising a pulse width modulation regulator, wherein the pulse width modulation regulator is configured to regulate the amount of electric current the supercapacitors of the first supercapacitor bank provide to the anode based on an instant off voltage of the mesh.

4. The system of claim 1, wherein the microcomputer controller is configured to perform at least one of:
lowering the potential between the anode and the mesh at night; and
maximizing the charge of the plurality of supercapacitors at sunset.

5. The system of claim 1, wherein the electrical current source comprises at least one of:
one or more photovoltaic cells configured to generate the electric current from light absorbed by the photovoltaic cells;
a wave action current generator configured to generate the electric current from one or more wave actions of the electrolytic media;
a thermoelectric generator configured to generate the electric current from thermal energy stored by the structure;
a sea water battery configured to generate the electric current from the electrolytic media; and
a wind generator configured to generate the electric current from wind force against a rotor thereof.

6. The system of claim 5, wherein the one or more photovoltaic cells are flexible and configured to cover at least a portion of a jacket surrounding at least a portion of the structure.

7. The system of claim 5, wherein the wind generator is a Savonius wind generator.

8. The system of claim 1, wherein the mesh is a titanium mesh.

9. An impressed current cathodic protection system, comprising:
an anode;
a pulse width modulation (PWM) regulator;
a microcomputer controller;
a mesh configured for attachment to at least a portion of a structure submerged in an electrolytic media; and
one or more supercapacitors,
wherein the microcomputer controller is configured to measure an instant off potential value of the mesh and compare the measured instant off potential value to a desired potential value, and
wherein the PWM regulator is configured to provide electric current from the one or more supercapacitors to the anode using pulse width modulation to maintain the instant off potential value of the mesh at the desired potential value.

10. The system of claim 9, wherein the microcomputer controller is configured to perform at least one of:
lowering the potential between the anode and the mesh at night; and
maximizing the charge of the one or more supercapacitors at sunset.

11. The system of claim 9, further comprising a direct current source configured to generate the electric current.

12. The system of claim 11, wherein the direct current source comprises at least one of:
one or more photovoltaic cells configured to generate the electric current from light absorbed by the photovoltaic cells;
a wave action current generator configured to generate the electric current from one or more wave actions of the electrolytic media;
a thermoelectric generator configured to generate the electric current from thermal energy stored by the structure;
a sea water battery configured to generate the electric current from the electrolytic media; and
a wind generator configured to generate the electric current from wind force against a rotor thereof.

13. The system of claim 11, wherein the PWM regulator comprises:
a metal-oxide-semiconductor field-effect transistor (MOSFET) switch, wherein a source terminal of the MOSFET switch is connected to the direct current source, and wherein a drain terminal of the MOSFET switch is connected to the anode;
a comparator integrated circuit (IC), wherein a first input of the comparator IC is configured for connection to a reference node configured to be attached to at least a portion of the structure submerged in the electrolytic media, wherein a second input of the comparator IC is configured for connection to a reference voltage, wherein the reference voltage is equal to the desired potential value, and wherein an output of the comparator IC is configured for connection to a gate terminal of the MOSFET switch;
a sample and hold (S&H) IC, wherein an input of the S&H IC is configured for connection to the reference node;
wherein the output of the comparator IC is at a high level when a voltage of the reference node is lower than the reference voltage, wherein the high level output of the comparator IC causes the MOSFET switch to turn on such that the electric current flows from the direct current source to the anode;
wherein the output of the comparator IC is at a low level when the voltage of the reference node is greater than or equal to the reference voltage, wherein the low level output of the comparator IC causes the MOSFET switch to turn off; and
wherein a falling edge of the low level output of the comparator IC triggers the S&H IC to read the input voltage of the reference node, wherein the S&H IC applies the input voltage to an output of the S&H IC as long as the trigger input is at a low level, and wherein, when the trigger input is at a high level, the output of the S&H IC stays at the voltage level present on the input of the S&H IC when the trigger input was at the low level.

14. The system of claim 13, wherein the reference node is one of a reference cell and the mesh.

15. The system of claim 13, wherein the reference voltage comprises a signal from a data acquisition system.

16. The system of claim 13, wherein the reference voltage comprises a signal from a manually adjustable potentiometer.

17. The system of claim 13, further comprising an inductor configured for connection in series between the drain terminal of the MOSFET switch and the anode.

18. The system of claim 17, further comprising a diode connected between the drain terminal of the MOSFET switch and the inductor, wherein the diode is configured to return the inductor current to the system.

19. A method, comprising:
charging a plurality of supercapacitors with electric current from an electric current source by configuring a plurality of switches to connect the supercapacitors in parallel with the electric current source;
measuring an instant off potential value of a mesh attached to at least a portion of a structure submerged in an electrolytic media;
comparing the measured instant off potential value to a desired potential value, the desired potential value comprising a desired voltage potential between an anode and the portion of the structure submerged in the electrolytic media; and
providing electric current from the supercapacitors to the anode when the measured instant off potential value differs from the desired voltage potential by configuring the plurality of switches to connect the supercapacitors in series with the anode and the mesh.

20. The method of claim 19, further comprising regulating, by a pulse width modulation regulator, the electric current provided from the supercapacitors to the anode by using pulse width modulation to maintain the instant off potential value of the mesh at the desired potential value.
